(19) United States
(12) Patent Application Publication
(10) Pub. No.: US 2026/0310004 A1
(43) Pub. Date: Oct. 8, 2026

(54) LENS ASSEMBLY

(71) Applicant: Luxshare Intelligent Manufacture Technology (Changshu) Co., Ltd., Changshu City (CN)

(72) Inventors: SinHong Lin, Changshu City (CN); ChiYing Lee, Changshu City (CN); HaoYun Lee, Changshu City (CN); JenCheng Sung, Changshu City (CN); WenYen Huang, Changshu City (CN)

(73) Assignee: Luxshare Intelligent Manufacture Technology (Changshu) Co., Ltd., Changshu City (CN)

(21) Appl. No.: 19/372,856

(22) Filed: Oct. 29, 2025

(30) Foreign Application Priority Data
Apr. 2, 2025 (CN) 202510413413.0

(51) Int. Cl. G02B 27/64; G02B 7/02

(52) U.S. Cl. CPC G02B 27/646; G02B 7/02

(57) ABSTRACT

A stopping structure of a lens assembly is disposed on opposite sides of a lens holder or a mounting base, and a first connection area and a second connection area of an elastic part are connected to the mounting base and the lens holder, respectively. By using the spaced first stopping part and second stopping part, the positioning accuracy of the stopping structure for the lens holder and the mounting base is improved. By arranging an elastic body between the first stopping part and the second stopping part, when the lens holder tilts towards one side of the elastic part, the tilt amplitude of the lens holder may be reduced, preventing excessive wear of the first stopping part or the second stopping part. Simultaneously, abnormal deformation of the elastic body may also be avoided. The service life of the elastic part, the lens holder, and the mounting base is ensured.

### CLAIM OF PRIORITY AND CROSS-REFERENCE TO RELATED APPLICATIONS

This application claims the benefit of Chinese Patent Application No. 202510413413.0, filed on April 2, 2025, which is incorporated herein by reference in its entirety.

### BACKGROUND OF THE DISCLOSURE

### 1. Field of the Disclosure

The present disclosure relates to the field of camera technology, and particularly to a lens assembly.

### 2. Description of the Related Art

In a lens assembly, a spring plate is disposed between a lens holder and a base, so that the lens holder is suspended on the base through the spring plate, thereby serving functions such as fixing the lens holder, driving the lens holder to reset, buffering, and shock absorption. However, it is difficult to ensure that the lens holder always moves along the axial direction of the lens, causing the lens holder to tilt when it abuts against the base through a limiting structure. Furthermore, this leads to wear of the limiting structure, the lens holder, or the base, as well as abnormal deformation of the spring plate. How to ensure the positional accuracy when the lens holder contacts the base has become a problem that needs to be solved.

### BRIEF DESCRIPTION OF THE DISCLOSURE

In view of this, embodiments of the present disclosure provide a lens assembly. A stopping structure is disposed on opposite sides of a lens holder and a mounting base, and a first stopping part and a second stopping part are respectively disposed on two sides of an elastic body. Thereby, when the lens holder abuts against the mounting base through the stopping structure, the first stopping part cooperates with the second stopping part to prevent excessive tilting of the lens holder, thereby ensuring the relative positional accuracy between the lens holder and the mounting base.

The lens assembly of the embodiment of the present disclosure comprises: a mounting base; a lens holder; an elastic part, comprising a first connection area, a second connection area, and an elastic body, the elastic body being connected between the first connection area and the second connection area, the first connection area being connected to the mounting base, the second connection area being connected to the lens holder; and a stopping structure, disposed on the lens holder and/or the mounting base, the stopping structure comprising a first stopping part and a second stopping part, the first stopping part and the second stopping part protruding towards the opposite sides of the lens holder and the mounting base, and the first stopping part and the second stopping part being located on two sides of the elastic body.

Further, a protrusion height of the second stopping part is greater than a protrusion height of the first stopping part, and a difference between the protrusion height of the second stopping part and the protrusion height of the first stopping part is within a predetermined range.

Further, the difference between the protrusion height of the second stopping part and the protrusion height of the first stopping part is C, wherein, C is greater than 0 and less than or equal to 0.0387 millimeters.

Further, the lens holder has a first contact position and a second contact position; at the first contact position, the lens holder and the mounting base abut against each other through the second stopping part, and the first stopping part is in a spaced state from the lens holder or the mounting base; at the second contact position, the lens holder and the mounting base abut against each other through the first stopping part and the second stopping part.

Further, the elastic body comprises a first connection end and a second connection end, the first connection end is connected to the first connection area, the second connection end is connected to the second connection area; the first stopping part is closer to the first connection end relative to the second stopping part.

Further, the first connection end is connected to a side of the first connection area close to the first stopping part; the second stopping part is located on a side of the first connection area away from the first stopping part, and the second connection area is disposed adjacent to the second stopping part.

Further, the mounting base has a first surface, the first surface protrudes with a first connection platform; the first connection area is disposed on a platform surface of the first connection platform, at least a portion of the elastic body is opposite to and spaced apart from the first surface.

Further, in a direction where the lens holder is projected onto the mounting base, at least a portion of the first stopping part and at least a portion of the second stopping part overlap with an edge area of the lens holder, and the first connection area is staggered from the lens holder.

Further, the lens holder has a second surface, the second surface faces the first surface, the second surface protrudes with a second connection platform; the second connection area is disposed on a platform surface of the second connection platform, at least a portion of the elastic body is opposite to and spaced apart from the second surface.

Further, the first connection area is a sheet-like structure, the protrusion height of the first stopping part and the second stopping part is greater than a thickness of the sheet-like structure; when the elastic part is in a free state, the first connection area corresponds to a side surface of the first stopping part and a side surface of the second stopping part.

Further, the elastic body comprises a first connection end and a second connection end, the first connection end is connected to the first connection area, the second connection end is connected to the second connection area; the first connection area has a first side edge, the first side edge is located on a side of the first connection area close to the lens holder and is at an edge of the first connection platform, the first connection end is connected to the first side edge.

Further, the first side edge comprises an avoidance segment and a connection segment in a length direction, the avoidance segment is located on the platform surface of the first connection platform, the connection segment, relative to the avoidance segment, is closer to an edge of the first connection platform and is connected to the first connection end; the first stopping part is disposed adjacent to the connection segment, the second stopping part is disposed adjacent to the avoidance segment.

Further, the first stopping part comprises a first stopping platform, the first stopping platform has a first stopping surface; the second stopping part comprises a second stopping platform, the second stopping platform has a second stopping surface; an area of the first stopping surface is larger than an area of the second stopping surface.

Further, a connecting line on a side of the first stopping surface and the second stopping surface away from the lens holder passes through the first connection end and is located on a side of the first side edge close to the lens holder.

Further, the first stopping platform and the second stopping platform are disposed on the mounting base, and the first stopping platform and the second stopping platform protrude towards the lens holder, a platform edge of the second stopping platform is provided with a rounded corner.

Further, the second stopping part further comprises a third stopping platform; the first stopping platform and the second stopping platform are disposed on the lens holder, and the first stopping platform and the second stopping platform protrude towards the mounting base, the third stopping platform is disposed on the mounting base, the third stopping platform protrudes towards the mounting base and corresponds to the second stopping platform, a platform edge of the second stopping platform and/or the third stopping platform is provided with a rounded corner.

Further, multiple first stopping parts and multiple second stopping parts form a plurality of stopping units; one of multiple elastic parts comprises a plurality of elastic units corresponding one-to-one to the plurality of stopping units, each elastic unit comprises the first connection area, the second connection area, and the elastic body, and the plurality of elastic units are located on sides of the plurality of elastic parts away from each other.

Further, two elastic parts are oppositely disposed, each elastic part comprises a connection body, two ends of the connection body are connected to two second connection areas; each elastic part comprises two elastic units, two first stopping parts corresponding to the same elastic part are located on sides of the two elastic units close to each other.

Further, the stopping structure further comprises: two third stopping parts, disposed on the lens holder and/or the mounting base, each third stopping parts protrudes towards the opposite sides of the lens holder and the mounting base, and a protrusion height of each third stopping parts is the same as that of the second stopping part; the two third stopping parts are respectively disposed corresponding to the two elastic parts, each third stopping part is located between the corresponding two first stopping parts.

Further, the stopping structure further comprises: two rotation limiting parts, respectively disposed corresponding to the two third stopping parts, the rotation limiting parts are disposed on the lens holder and/or the mounting base and protrude towards the opposite sides of the lens holder and the mounting base, a side surface of the rotation limiting part is at least partially opposite to a side surface of the third stopping part.

The lens assembly of the embodiment of the present disclosure disposes the stopping structure on the opposite sides of the lens holder or the mounting base, and connects the first connection area and the second connection area of the elastic part to the mounting base and the lens holder, respectively. Thereby, by using the spaced first stopping part and second stopping part, the positioning accuracy of the stopping structure for the lens holder and the mounting base is improved. On the other hand, by arranging the elastic body between the first stopping part and the second stopping part, when the lens holder tilts towards one side of the elastic part, the tilt amplitude of the lens holder may be reduced, preventing excessive wear of the first stopping part or the second stopping part. Simultaneously, abnormal deformation of the elastic body may also be avoided. The service life of the elastic part, the lens holder, and the mounting base is ensured.

### BRIEF DESCRIPTION OF THE DRAWINGS

Through the description of the embodiments of the present disclosure with reference to the following drawings, the above and other objects, features, and advantages of the present disclosure will become more apparent. In the drawings:

FIG. 1 is a structural schematic diagram of one side of a lens assembly according to a first embodiment of the present disclosure;

FIG. 2 is a structural schematic diagram of another side of the lens assembly according to the first embodiment of the present disclosure;

FIG. 3 is a structural schematic diagram of yet another side of the lens assembly according to the first embodiment of the present disclosure;

FIG. 4 is a structural schematic diagram of one side of a lens assembly according to a second embodiment of the present disclosure;

FIG. 5 is a structural schematic diagram of another side of the lens assembly according to the second embodiment of the present disclosure;

FIG. 6 is a partial structural schematic diagram of the lens assembly according to the second embodiment of the present disclosure;

FIG. 7 is an exploded view of the lens assembly according to the first embodiment of the present disclosure;

FIG. 8 is an enlarged view of area A in FIG. 3;

FIG. 9 is an exploded view of the lens assembly according to the second embodiment of the present disclosure;

FIG. 10 is an enlarged view of area B in FIG. 5;

FIG. 11 is a dimensional schematic diagram of a stopping structure according to the first embodiment of the present disclosure;

FIG. 12 is a dimensional schematic diagram of a stopping structure according to the second embodiment of the present disclosure;

FIG. 13 is a schematic diagram of the motion state of the lens assembly according to an embodiment of the present disclosure;

FIG. 14 is a cross-sectional schematic diagram of the lens assembly according to the first embodiment of the present disclosure;

FIG. 15 is a structural schematic diagram of an elastic part and a mounting base according to the first embodiment of the present disclosure;

FIG. 16 is a structural schematic diagram of one side of an elastic part and a mounting base according to the second embodiment of the present disclosure;

FIG. 17 is a structural schematic diagram of another side of the elastic part and the mounting base according to the second embodiment of the present disclosure;

FIG. 18 is a schematic diagram of the positional relationship between the elastic part and the mounting base according to the first embodiment of the present disclosure;

FIG. 19 is a partial schematic diagram of the elastic part according to the first embodiment of the present disclosure;

FIG. 20 is a schematic diagram of the positional relationship between the elastic part and the lens holder according to the second embodiment of the present disclosure;

FIG. 21 is a partial schematic diagram of the elastic part according to the second embodiment of the present disclosure.

### DETAILED DESCRIPTION OF EMBODIMENTS OF THE DISCLOSURE

The present disclosure is described based on embodiments, but the present disclosure is not limited to these embodiments. In the following detailed description of the present disclosure, some specific details are described in detail. Those skilled in the art can fully understand the present disclosure without the description of these details. In order to avoid obscuring the essence of the present disclosure, well-known methods, procedures, flows, components, and circuits are not described in detail.

Furthermore, it should be understood by those of ordinary skill in the art that the drawings provided herein are for illustrative purposes, and the drawings are not necessarily drawn to scale.

Unless the context clearly requires otherwise, throughout the description and the claims, the words "comprise", "include", and the like are to be construed in an inclusive sense as opposed to an exclusive or exhaustive sense; that is to say, in the sense of "including but not limited to".

In the description of the present disclosure, it should be understood that the terms "first", "second", etc. are used for descriptive purposes only and cannot be understood as indicating or implying relative importance. In addition, in the description of the present disclosure, unless otherwise specified, "a plurality of" means two or more.

Unless otherwise explicitly specified and defined, terms such as "mount", "connect", "link", "fix", etc. should be understood in a broad sense. For example, it may be a fixed connection, a detachable connection, or an integral connection; it may be a direct connection, or an indirect connection through an intermediary; it may be an internal communication between two components or an interaction relationship between two components. Those of ordinary skill in the art can understand the specific meanings of the above terms in the present disclosure according to specific situations.

For ease of description, spatial relative terms such as "inside", "outside", "under", "below", "lower portion", "above", "upper portion", etc., may be used herein to describe the relationship between one element or feature illustrated in the figures and another element or feature. It will be understood that the spatial relative terms are intended to encompass different orientations of the device in use or operation in addition to the orientation depicted in the figures. For example, if the device in the figures is turned over, elements described as being "below" or "beneath" other elements or features would then be oriented "above" the other elements or features. Thus, the exemplary term "below" can encompass both an orientation of above and below. The device may be otherwise oriented (rotated 90 degrees or at other orientations) and the spatial relative descriptors used herein are to be interpreted accordingly.

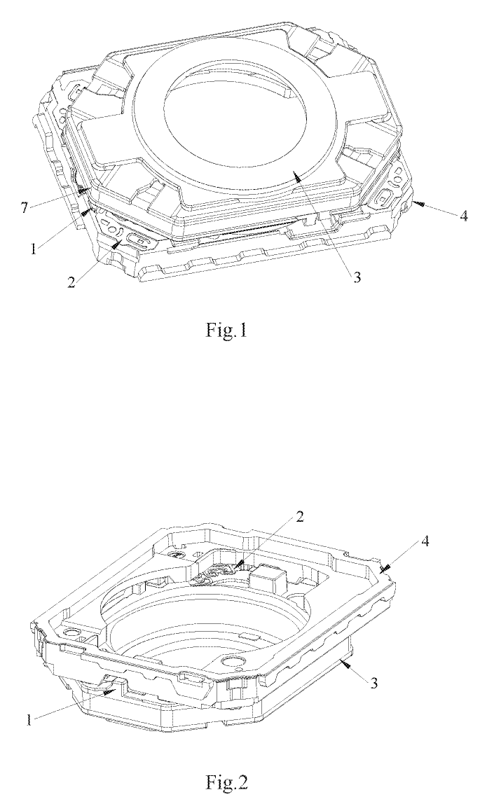

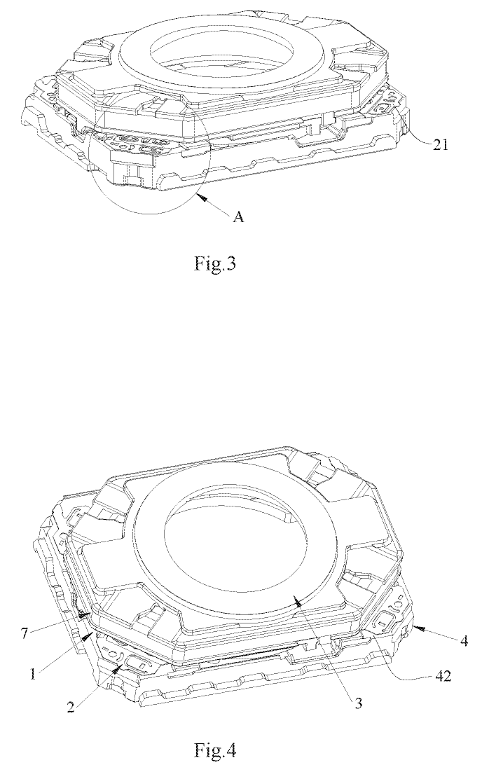

FIGS. 1 to 3 are structural schematic diagrams of a lens assembly according to a first embodiment. FIGS. 4 to 6 are structural schematic diagrams of a lens assembly according to a second embodiment.

In some embodiments, as shown in FIGS. 1 to 6, the lens assembly in this embodiment includes a stopping structure 1, an elastic part 2, a lens holder 3, a mounting base 4, and a coil 7. The coil 7 is disposed on the lens holder 3. The stopping structure 1 is disposed on the lens holder 3 and/or the mounting base 4, and the stopping structure 1 is located on opposite sides of the lens holder 3 and the mounting base 4. When the lens holder 3 and the mounting base 4 move close to each other, it is used to limit the relative position between the lens holder 3 and the mounting base 4.

Further, the lens assembly further includes a lens and a magnetic assembly. The lens is disposed in a fixing hole of the lens holder 3. The magnetic field generated when the coil 7 is energized may act on the magnetic assembly, thereby using the magnetic assembly to drive the lens to move.

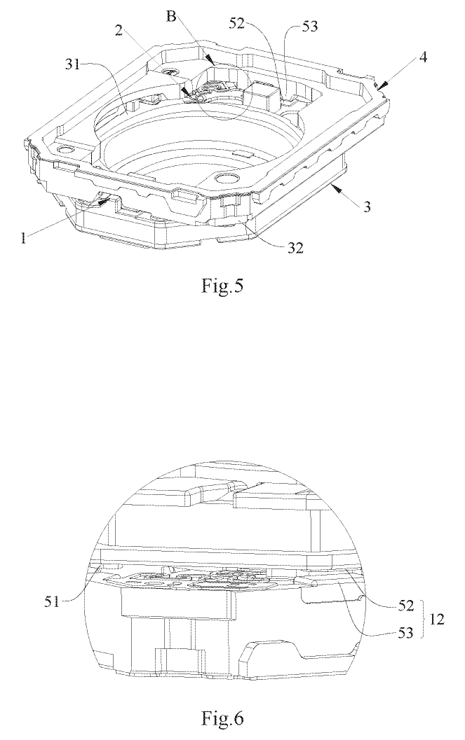

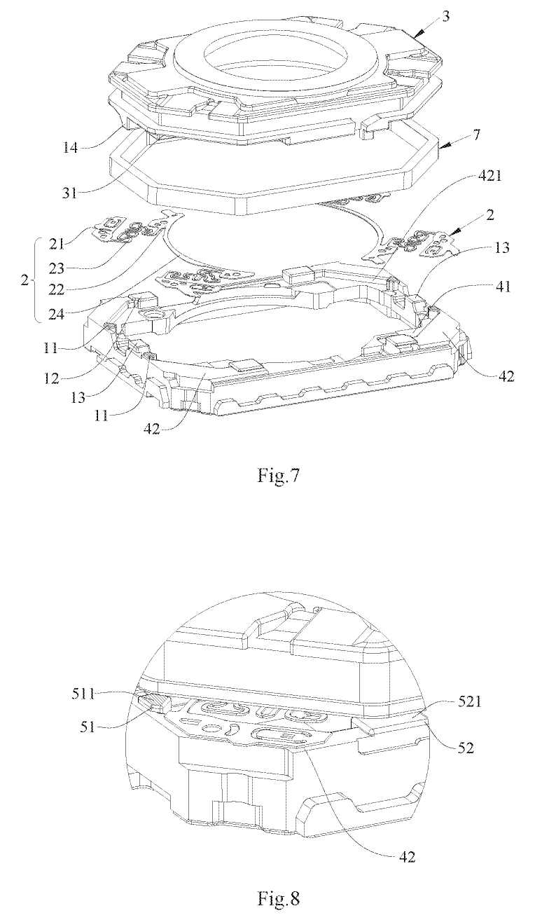

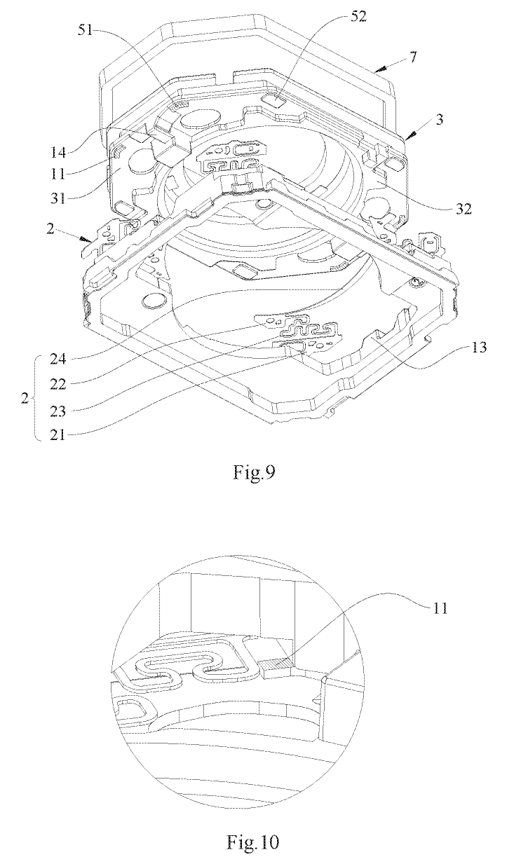

FIG. 7 is an exploded view of the lens assembly according to the first embodiment. FIG. 8 is an enlarged view of area A in FIG. 3. FIG. 9 is an exploded view of the lens assembly according to the second embodiment. FIG. 10 is an enlarged view of area B in FIG. 5.

Further referring to FIGS. 7 to 10, the elastic part 2 includes a first connection area 21, a second connection area 22, and an elastic body 23. The elastic body 23 is connected between the first connection area 21 and the second connection area 22. The first connection area 21 is connected to the mounting base 4, and the second connection area 22 is connected to the lens holder 3.

Optionally, the first connection area 21 and the second connection area 22 may be fixed on the outer surfaces of the mounting base 4 and the lens holder 3, respectively. For example, they may be fixed by adhesive or welding. Or, using an insert molding process, the first connection area 21 and the second connection area 22 are used as inserts and disposed inside the mounting base 4 and the lens holder 3, respectively.

Specifically, the second connection area 22 and the lens holder 3, as well as the first connection area 21 and the mounting base 4, are first fixed by adhesive, and then the first connection area 21 and the mounting base 4 are fixed again by welding.

Further referring to FIGS. 1 to 10, the stopping structure 1 includes a first stopping part 11 and a second stopping part 12. The first stopping part 11 and the second stopping part 12 are disposed in pairs. The first stopping part 11 and the second stopping part 12 protrude towards the opposite sides of the lens holder 3 and the mounting base 4, and the first stopping part 11 and the second stopping part 12 are located on two sides of the elastic body 23.

Specifically, when the magnetic force of the magnetic assembly disappears, under the resetting elastic force of the elastic body 23, the lens holder 3 will move close to the mounting base 4 until the lens holder 3 collides with the mounting base 4 through the stopping structure 1. Then, the lens holder 3 will separate from the mounting base 4 again, causing the lens holder 3 to hover above the mounting base 4. In this form, there is a certain gap between the lens holder 3 and the mounting base 4.

Optionally, the first stopping part 11 and the second stopping part 12 are both disposed on the mounting base 4, causing the first stopping part 11 and the second stopping part 12 to protrude towards the lens holder 3 simultaneously. Thereby, the overall weight of the lens holder 3 is reduced, and when the magnetic assembly drives the lens holder 3 to move, the response speed of the lens holder 3 may be improved.

Optionally, the first stopping part 11 and the second stopping part 12 are both disposed on the lens holder 3, causing the first stopping part 11 and the second stopping part 12 to protrude towards the mounting base 4 simultaneously. Thereby, the overall mechanical strength of the lens holder 3 is improved.

Optionally, the first stopping part 11 is disposed on the lens holder 3, and the second stopping part 12 is disposed on the mounting base 4. Or, the first stopping part 11 is disposed on the mounting base 4, and the second stopping part 12 is disposed on the lens holder 3. Thereby, it is convenient for those skilled in the art to control the center of gravity of the lens holder 3 through the stopping structure 1, ensuring the motion accuracy of the lens holder 3.

Specifically, the stopping structure 1 is integrally injection molded with the lens holder 3 and/or the mounting base 4. The injection material may be engineering plastic (for example, ET530). Thereby, it is ensured that the stopping structure 1 has certain wear resistance.

In summary, in the lens assembly of this embodiment, the stopping structure 1 is disposed on the opposite sides of the lens holder 3 or the mounting base 4, and the first connection area 21 and the second connection area 22 of the elastic part 2 are connected to the mounting base 4 and the lens holder 3, respectively. Thereby, by using the spaced first stopping part 11 and second stopping part 12, the positioning accuracy of the stopping structure 1 for the lens holder 3 and the mounting base 4 is improved. On the other hand, by arranging the elastic body 23 between the first stopping part 11 and the second stopping part 12, when the lens holder 3 tilts towards one side of the elastic part 2, the tilt amplitude of the lens holder 3 may be reduced, preventing excessive wear of the first stopping part 11 or the second stopping part 12. Simultaneously, abnormal deformation of the elastic body 23 may also be avoided. The service life of the elastic part 2, the lens holder 3, and the mounting base 4 is ensured.

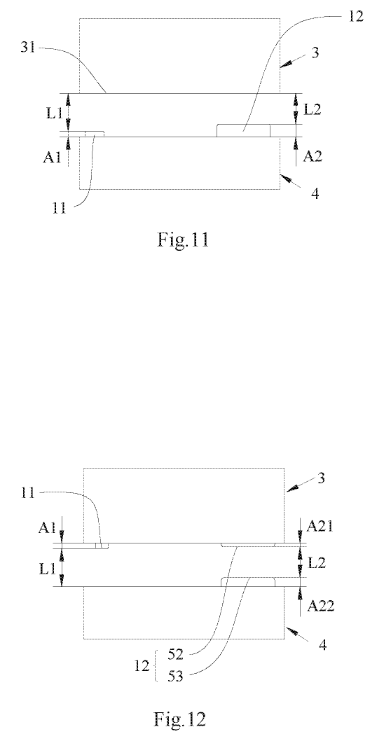

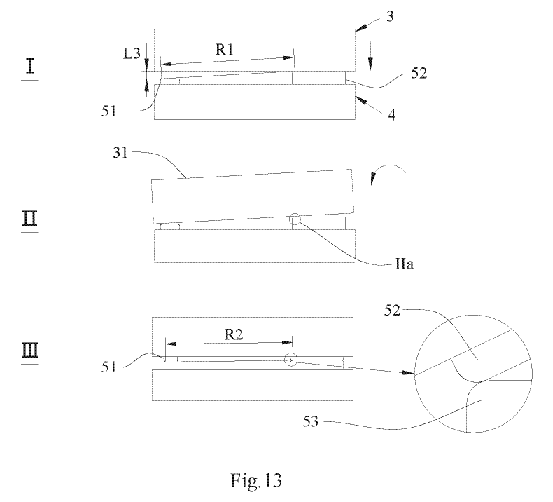

FIG. 11 is a dimensional schematic diagram of the stopping structure 1 according to the first embodiment of the present disclosure. FIG. 12 is a dimensional schematic diagram of the stopping structure 1 according to the second embodiment of the present disclosure. FIG. 13 is a schematic diagram of the motion state of the lens assembly.

Specifically, as shown in FIG. 11, the first stopping part 11 and the second stopping part 12 protrude from the mounting base 4. The height of the first stopping part 11 is dimension A1, and the height of the second stopping part 12 is dimension A2. The lens holder 3 in the figure hovers above the mounting base 4, that is, the lens holder 3 is in a stationary state. The lens holder 3 has a second surface 31 that cooperates with the stopping structure 1. In this form, the distances from the first stopping part 11 and the second stopping part 12 to the second surface 31 are dimension L1 and dimension L2, respectively.

Specifically, as shown in FIG. 12, the first stopping part 11 protrudes from the lens holder 3, and the second stopping part 12 is simultaneously disposed on the lens holder 3 and the mounting base 4. The height of the first stopping part 11 is dimension A1, and the height of the second stopping part 12 is dimension A2. Herein, the second stopping part 12 includes a second stopping platform 52 and a third stopping platform 53. The height dimensions of the second stopping platform 52 and the third stopping platform 53 are dimension A21 and dimension A22, respectively. That is, the sum of dimension A21 and dimension A22 equals dimension A2.

Specifically, as shown in FIG. 13, state I and state II correspond to the first embodiment described above. State III corresponds to the second embodiment described above. In state I and state III, the lens holder 3 touches the stopping structure 1 along the axial direction of the lens or substantially along the axial direction of the lens. In this form, the second stopping part 12 abuts against the lens holder 3 (the second stopping platform 52 and the third stopping platform 53 abut against each other), while the first stopping part 11 remains spaced from the lens holder 3 or the mounting base 4. In addition, the enlarged view of state III shows the state at the edge positions of the second stopping platform 52 and the third stopping platform 53 after the lens holder 3 tilts. In state II, the lens holder 3 touches the second stopping part 12 and then tilts, causing a portion of the second surface 31 to abut against the first stopping part 11. That is, the lens holder 3 has a secondary collision with the stopping structure 1.

In state I, the lens holder 3 flips along one side edge of the second stopping platform 52, and the flip radius is approximately R1. In state III, the lens holder 3 flips along the edges of the second stopping platform 52 and the third stopping platform 53, and the flip radius is approximately R2. It can be seen from the figure that the height difference between the first stopping platform 51 and the second stopping platform 52 in state I is greater than the height difference between the first stopping platform 51 and the second stopping platform 52 in state III. Thereby, R1 is greater than R2. Therefore, when a secondary collision occurs in the stopping structure 1, the tilt amplitude in state I is greater than that in state III.

In some embodiments, as shown in FIGS. 11 to 12, the protrusion height of the second stopping part 12 is configured to be greater than the protrusion height of the first stopping part 11, and the difference between the protrusion height of the second stopping part 12 and the protrusion height of the first stopping part 11 is within a predetermined range. That is, dimension A2 is greater than dimension A1.

Thereby, the height dimensions of the first stopping part 11 and the second stopping part 12 in this embodiment are configured to be different, reducing the occurrence of situations where the lens holder 3 or the mounting base 4 contacts both the first stopping part 11 and the second stopping part 12 simultaneously, that is, reducing the contact area between the stopping structure 1 and the lens holder 3 or the mounting base 4. Thus, it helps those skilled in the art to control the relative distance between the lens holder 3 and the mounting base 4 through the stopping structure 1. Simultaneously, wear of the stopping structure 1 may also be reduced.

In some embodiments, as shown in FIGS. 11 to 13, the lens holder 3 has a first contact position and a second contact position.

It is easy to understand that the elastic deformation of the elastic part 2 has uncontrollable factors. That is, in some cases, the lens holder 3 may move along the axial direction. But in other cases, the deformation generated by the elastic body 23 causes the lens holder 3 to flip randomly in an undirected manner.

In this embodiment, when the motion trajectory of the lens holder 3 is relatively stable, it will contact the mounting base 4 at the first contact position and then move away from the mounting base 4 after contact. During this process, the lens holder 3 and the mounting base 4 abut against each other through the second stopping part 12, and the first stopping part 11 is in a spaced state from the lens holder 3 or the mounting base 4. When the motion trajectory of the lens holder 3 is unstable (for example, the speed of the lens holder 3 is too fast or the elastic part 2 generates unstable deformation due to its own defects), the lens holder 3 will first contact the second stopping part 12, then tilt, and contact the first stopping part 11 at the second contact position. In this form, the lens holder 3 and the mounting base 4 abut against each other through the first stopping part 11 and the second stopping part 12 and, after abutting, cause the lens holder 3 and the mounting base 4 to move away from each other.

Optionally, the second surface 31 is a plane, dimension A2 is greater than dimension A1, making dimension L2 greater than dimension L1. The second surface 31 is perpendicular or substantially perpendicular to the moving direction of the lens holder 3. Taking the stopping structure 1 disposed on the mounting base 4 as an example, as shown in FIG. 11 and FIG. 13, in this embodiment, when the motion trajectory of the lens holder 3 is stable, the lens holder 3 is limited by the second stopping part 12, reducing the contact area between the lens holder 3 and the stopping structure 1. Furthermore, the positioning accuracy is improved. In addition, wear between the lens holder 3 and the stopping structure 1 is also reduced. On the other hand, when the motion trajectory of the lens holder 3 is unstable, the lens holder 3 contacts the second stopping part 12 and then tilts. In this form, the first stopping part 11, which has a height smaller than that of the second stopping part 12, is used to limit the lens holder 3, preventing the tilt amplitude of the lens holder 3 from being too large, and also limiting the deformation amplitude of the elastic body 23. As shown in area IIa in FIG. 13, using the first stopping part 11 may also prevent the edge of the second stopping part 12 from being excessively worn, causing the top surface of the second stopping part 12 to tilt.

In some embodiments, as shown in FIGS. 11 to 12, the difference between the protrusion height of the second stopping part 12 and the protrusion height of the first stopping part 11 is C. Wherein, C is greater than 0 and less than or equal to 0.0387 millimeters. That is, the value of dimension A2 minus dimension A1 is greater than 0 and less than or equal to 0.0387 millimeters. Optionally, C may be configured to be 0.01 millimeters.

It is easy to understand that this embodiment considers the influence of tolerances generated by the stopping structure 1, the lens holder 3, and the mounting base 4 on the height difference between the first stopping part 11 and the second stopping part 12. The standard deviation of the dimensions of the lens holder 3, the mounting base 4, and the stopping structure 1 is controlled to 3σ, so that the lens assembly may meet the requirement for the height difference between the first stopping part 11 and the second stopping part 12 in 99.7% of cases.

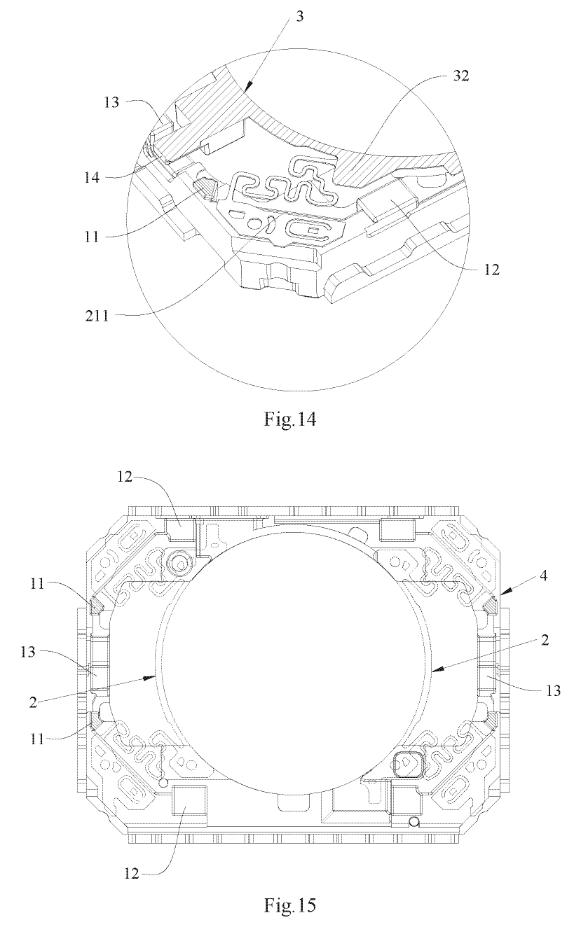

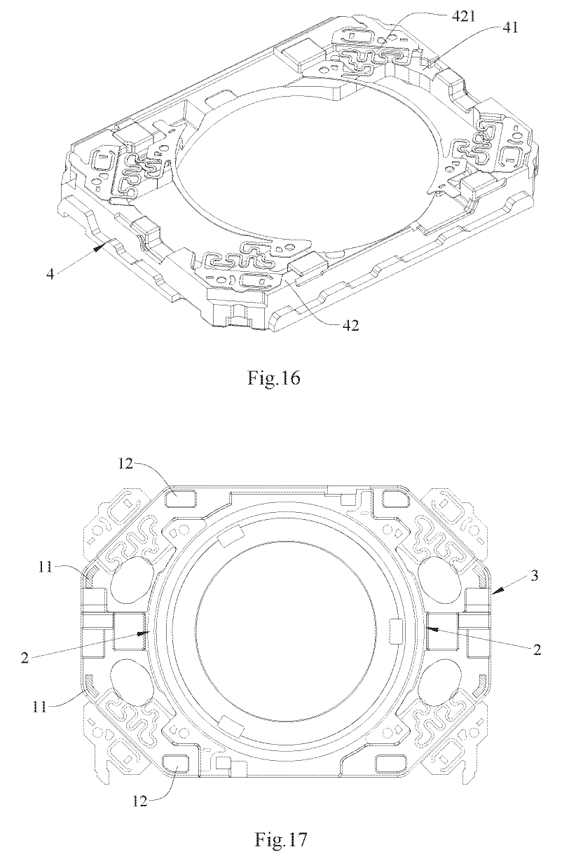

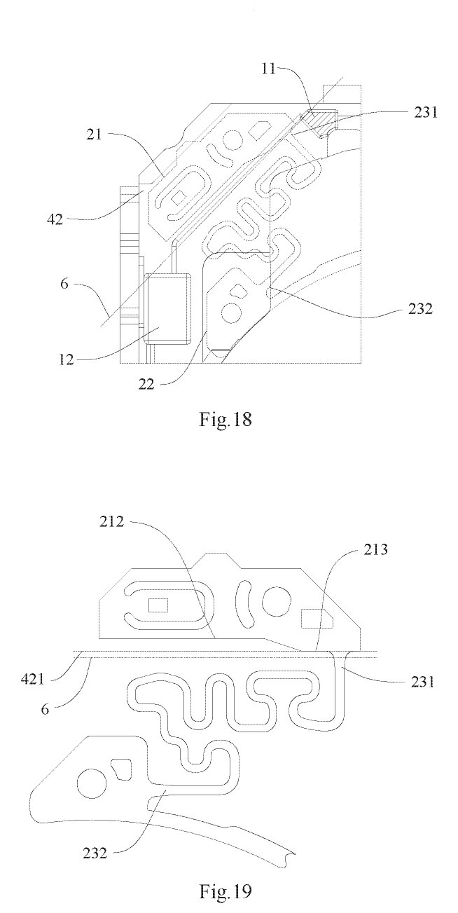

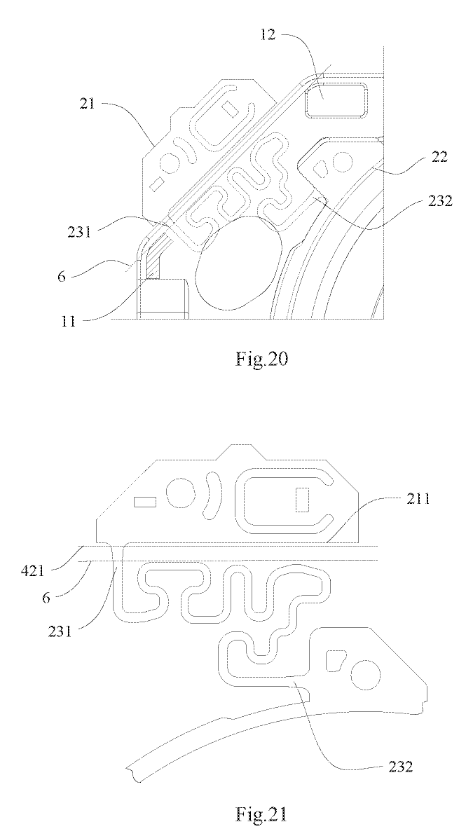

FIG. 14 is a cross-sectional schematic diagram of the lens assembly according to the first embodiment of the present disclosure. FIG. 15 is a structural schematic diagram of the elastic part 2 and the mounting base 4 according to the first embodiment of the present disclosure. FIG. 16 and FIG. 17 are structural schematic diagrams of the elastic part 2 and the mounting base 4 according to the second embodiment of the present disclosure. FIG. 18 is a schematic diagram of the positional relationship between the elastic part 2 and the mounting base 4 according to the first embodiment of the present disclosure. FIG. 19 is a partial schematic diagram of the elastic part 2 according to the first embodiment of the present disclosure. FIG. 20 is a schematic diagram of the positional relationship between the elastic part 2 and the lens holder 3 according to the second embodiment of the present disclosure. FIG. 21 is a partial schematic diagram of the elastic part 2 according to the second embodiment of the present disclosure. The top surfaces of the first stopping part 11 in each figure are drawn with section lines to distinguish them from the second stopping part 12 and the third stopping part 13.

In some embodiments, as shown in FIGS. 14 to 21, the elastic body 23 includes a first connection end 231 and a second connection end 232. The first connection end 231 is connected to the first connection area 21, and the second connection end 232 is connected to the second connection area 22. The stopping structure 1 is configured such that the first stopping part 11 is closer to the first connection end 231 relative to the second stopping part 12.

Specifically, the elastic body 23 is a strip-like structure. The elastic body 23 extends curvedly from the first connection area 21 to the second connection area 22. In this embodiment, during the up-and-down movement of the lens holder 3, when the elastic part 2 undergoes elastic deformation, in the extending direction of the elastic body 23, the deformation amplitude of the area near the first connection end 231 is smaller than the deformation amplitude of the middle area of the elastic body 23. This causes less bending deformation in the thickness direction of the strip-like structure and more circumferential torsional deformation along the extending direction of the strip-like structure in the area near the first connection end 231.

For this purpose, the second stopping part 12 is disposed away from the first connection end 231. When the lens holder 3 shifts along the radial direction of the lens or flips in a direction away from the first stopping part 11, the second stopping part 12 may limit it preferentially, ensuring the contact area between the second stopping part 12 and the lens holder 3. The first stopping part 11 adjacent to the first connection end 231 may effectively limit the flip amplitude of the lens holder 3 when it flips.

In some embodiments, as shown in FIGS. 14 to 21, the first connection end 231 is connected to a side of the first connection area 21 closer to the first stopping part 11. The second stopping part 12 is located on a side of the first connection area 21 away from the first stopping part 11, and the second connection area 22 is disposed adjacent to the second stopping part 12.

Specifically, in the axial cross-sectional direction of the lens, the second stopping part 12 and the second connection area 22 are staggered. In this embodiment, under the driving of the lens holder 3, the second connection area 22 has the largest movement amplitude. Staggering the second connection area 22 and the second stopping part 12 may prevent the second connection area 22 from contacting the second stopping part 12. Simultaneously, when the second connection area 22 drives the lens holder 3 to move, the contact area between the second stopping part 12 and the lens holder 3 may also be ensured.

In some embodiments, as shown in FIG. 16, the mounting base 4 has a first surface 41, and the first surface 41 protrudes with a first connection platform 42. The first connection area 21 is disposed on a platform surface of the first connection platform 42, and at least a portion of the elastic body 23 is opposite to and spaced apart from the first surface 41. Specifically, the first connection platform 42 is located at an edge position of the mounting base 4. In this embodiment, when the elastic body 23 bends and deforms, contact between the elastic body 23 and the mounting base 4 may be avoided, and sufficient deformation space for the elastic part 2 is ensured.

In some embodiments, as shown in FIGS. 1 to 6, in the direction where the lens holder 3 is projected onto the mounting base 4, at least a portion of the first stopping part 11 and at least a portion of the second stopping part 12 overlap with an edge area of the lens holder 3, and the first connection area 21 is staggered from the lens holder 3.

The first connection area 21 in this embodiment extends laterally towards the side of the lens holder 3 and is exposed outside the lens holder 3. Thereby, it is convenient for operators to assemble the lens holder 3, the mounting base 4, and the elastic part 2. For example, first, the second connection area 22 is fixedly connected to the lens holder 3, then the elastic part 2 and the lens holder 3 are placed on the edge of the mounting base 4 through the first connection area 21. Finally, the first connection area 21 is bonded or welded to the mounting base 4.

In some embodiments, as shown in FIGS. 5, 9, and 14, the lens holder 3 has a second surface 31, the second surface 31 faces the first surface 41, and the second surface 31 protrudes with a second connection platform 32. The second connection area 22 is disposed on a platform surface of the second connection platform 32, and at least a portion of the elastic body 23 is opposite to and spaced apart from the second surface 31. The area between the first surface 41 and the second surface 31 in this embodiment forms a deformation space for the elastic body 23 to bend and deform, preventing the elastic body 23 from bumping against the lens holder 3 or the mounting base 4.

Further, as shown in FIG. 8, the first connection area 21 is a sheet-like structure, and the protrusion height of the first stopping part 11 and the second stopping part 12 is greater than the thickness of the sheet-like structure. When the elastic part 2 is in a free state, the first connection area 21 corresponds to a side surface of the first stopping part 11 and a side surface of the second stopping part 12. Thereby, direct contact between the lens holder 3 and the first connection area 21, which would cause squeezing of the first connection area 21, is avoided.

In some embodiments, as shown in FIGS. 18 to 21, the elastic body 23 includes a first connection end 231 and a second connection end 232. The first connection end 231 is connected to the first connection area 21, and the second connection end 232 is connected to the second connection area 22. The first connection area 21 has a first side edge 211. The first side edge 211 is located on a side of the first connection area 21 close to the lens holder 3 and is at an edge of the first connection platform 42. The first connection end 231 is connected to the first side edge 211. Thereby, contact between the first connection end 231 and the top of the first connection platform 42 is avoided. When the strip-like structure bends and deforms, collision between the first connection end 231 and the first connection platform 42 may be prevented.

In some embodiments, as shown in FIGS. 18 to 19, the first side edge 211 includes an avoidance segment 212 and a connection segment 213 in a length direction. The avoidance segment 212 is located on the platform surface of the first connection platform 42. The connection segment 213, relative to the avoidance segment 212, is closer to an edge of the first connection platform 42 and is connected to the first connection end 231. The first stopping part 11 is disposed adjacent to the connection segment 213, and the second stopping part 12 is disposed adjacent to the avoidance segment 212.

Optionally, the connection segment 213 is aligned with the edge line of the platform surface of the first connection platform 42, or the connection segment 213 is configured to be aligned with a first side surface 421 of the first connection platform 42. The first side surface 421 faces the central area of the mounting base 4 and is connected to the first surface 41.

Thereby, the avoidance segment 212 may prevent the edge of the lens holder 3 from being scratched by the first connection area 21, which would cause material falling off the lens holder 3 to form dust attached to the lens assembly, affecting the imaging effect of the lens assembly. On the other hand, by spacing the first connection end 231 apart from the first connection platform 42, interference between the deformation of the elastic body 23 and the first connection platform 42 is avoided. Simultaneously, by disposing the first stopping part 11 adjacent to the connection segment 213, contact between the lens holder 3 and the first connection area 21 after the lens holder 3 tilts is prevented to the greatest extent.

In some embodiments, as shown in FIGS. 14 to 17, the first stopping part 11 includes a first stopping platform 51, and the first stopping platform 51 has a first stopping surface 511. The second stopping part 12 includes a second stopping platform 52, and the second stopping platform 52 has a second stopping surface 521. The area of the first stopping surface 511 is larger than the area of the second stopping surface 521.

The area of the first stopping surface 511 in this embodiment is smaller, which may reduce wear between the first stopping surface 511 and the lens holder 3 or the mounting base 4. Furthermore, taking FIG. 13 as an example, when the lens holder 3 contacts the first stopping part 11, only a portion of the first stopping part 11 contacts the lens holder 3. For this purpose, in this embodiment, reducing the area of the first stopping surface 511 may reduce the overall weight of the lens assembly, making it easier for those skilled in the art to control the height of the first stopping part 11.

In some embodiments, as shown in FIGS. 18 to 21, a connecting line 6 on a side of the first stopping surface 511 and the second stopping surface 521 away from the lens holder 3 passes through the first connection end 231 and is located on a side of the first side edge 211 close to the lens holder 3.

Specifically, the connecting line 6 is located on a side of the connection segment 213 close to the lens holder 3. The connecting line 6 in this embodiment is a virtual line segment. This line segment is formed by connecting the side walls of the first stopping part 11 and the second stopping part 12 on the side away from the fixing hole. When the lens holder 3 flips towards the first connection platform 42, under the driving of the lens holder 3, the edge of the first connection area 21 may be prevented from being lifted off the top of the first connection platform 42. Furthermore, stable connection between the first connection area 21 and the first connection platform 42 is ensured. In addition, the deformation amplitude between the first connection end 231 and the first side edge 211 may be further limited, preventing fatigue damage at the connection position between the first connection end 231 and the first side edge 211.

In some embodiments, as shown in FIGS. 1 to 3 and 11, the first stopping platform 51 and the second stopping platform 52 are disposed on the mounting base 4, and the first stopping platform 51 and the second stopping platform 52 protrude towards the lens holder 3. The first stopping platform 51 and the second stopping platform 52 in this embodiment are used to cooperate with the second surface 31 to serve the function of limiting the displacement of the lens holder 3. Simultaneously, the weight of the lens holder 3 is reduced.

In some embodiments, as shown in FIGS. 4 to 6 and 12, the second stopping part 12 further includes a third stopping platform 53. The first stopping platform 51 and the second stopping platform 52 are disposed on the lens holder 3, and the first stopping platform 51 and the second stopping platform 52 protrude towards the mounting base 4. The third stopping platform 53 is disposed on the mounting base 4, and the third stopping platform 53 protrudes towards the mounting base 4 and corresponds to the second stopping platform 52.

The protrusion height of the second stopping part 12 in this embodiment is the sum of the protrusion heights of the second stopping platform 52 and the third stopping platform 53. Thereby, the height difference between the second stopping platform 52 and the third stopping platform 53 is reduced, the rotation radius of the lens holder 3 is reduced (as shown by R1 and R3 in FIG. 13), and thus the tilt angle of the lens holder 3 is reduced.

Further, the top edges of the first stopping platform 51, the second stopping platform 52, and the third stopping platform 53 are provided with rounded corners. Taking state II in FIG. 13 as an example, when the lens holder 3 tilts, the lens holder 3 may roll along the rounded corners until the lens holder 3 abuts against the first stopping part 11. Thereby, friction between the lens holder 3 and the second stopping part 12 is reduced. Taking state III in FIG. 13 as an example, when the lens holder 3 tilts, the rounded corner provided on the second stopping platform 52 may roll along the rounded corner provided on the third stopping platform 53, further reducing wear of the stopping structure 1.

In some embodiments, as shown in FIGS. 15 to 17, multiple first stopping parts 11 and multiple second stopping parts 12 form a plurality of stopping units. One of multiple elastic parts 2 includes a plurality of elastic units corresponding one-to-one to the plurality of stopping units. Each elastic unit includes the first connection area 21, the second connection area 22, and the elastic body 23, and the plurality of elastic units are located on sides of the plurality of elastic parts 2 away from each other. This embodiment uses multiple elastic units to cooperate with corresponding multiple stopping units to perform limiting simultaneously in the circumferential direction of the lens, further restricting the movement of the lens holder 3 in various directions.

In some embodiments, as shown in FIGS. 7 to 10, the number of the elastic part 2 is two. The two elastic parts 2 are oppositely disposed. The elastic part 2 includes a connection body 24, and two ends of the connection body 24 are connected to two second connection areas 22. Further referring to FIGS. 15 and 17, the elastic part 2 includes two elastic units. Two first stopping parts 11 corresponding to the same elastic part 2 are located on sides of the two elastic units close to each other. Thereby, this embodiment limits the flip amplitude of the lens holder 3 along the arrangement direction of the two elastic parts 2, ensuring the consistency of the deformation of the two elastic parts 2.

In some embodiments, as shown in FIGS. 7, 9, and 13, the stopping structure 1 further includes two third stopping parts 13. The two third stopping parts 13 are disposed on the lens holder 3 and/or the mounting base 4. The third stopping parts 13 protrude towards the opposite sides of the lens holder 3 and the mounting base 4, and the protrusion height of the third stopping parts 13 is the same as that of the second stopping part 12. The two third stopping parts 13 are respectively disposed corresponding to the two elastic parts 2, and the third stopping part 13 is located between the corresponding two first stopping parts 11.

Optionally, as shown in FIGS. 7 and 15, the height of the top surfaces of the two third stopping parts 13 is level with the height of the top surface of the second stopping part 12. Thereby, stable contact between the lens holder 3 and the stopping structure 1 is ensured, reducing the occurrence of tilting.

Further referring to FIGS. 7 and 9, the stopping structure 1 further includes two rotation limiting parts 14. The two rotation limiting parts 14 are respectively disposed corresponding to the two third stopping parts 13. The rotation limiting parts 14 are disposed on the lens holder 3 and/or the mounting base 4 and protrude towards the opposite sides of the lens holder 3 and the mounting base 4. A side surface of the rotation limiting part 14 is at least partially opposite to a side surface of the third stopping part 13. The rotation limiting parts 14 in this embodiment are used to cooperate with the third stopping parts 13 to limit the rotation amplitude of the lens holder 3.

Specifically, as shown in FIG. 7, the two rotation limiting parts 14 are disposed on the lens holder 3. When the first stopping part 11 and the second stopping part 12 simultaneously abut against the lens holder 3, the end surfaces of the rotation limiting parts 14 remain spaced from the mounting base 4. Thereby, it is ensured that the side surfaces of the rotation limiting parts 14 may abut against the side surfaces of the third stopping parts 13 to achieve limitation of the rotation amplitude of the lens holder 3.

The above are only preferred embodiments of the present disclosure and are not intended to limit the present disclosure. For those skilled in the art, the present disclosure may have various modifications and changes. Any modifications, equivalent replacements, improvements, etc., made within the spirit and principle of the present disclosure shall be included within the protection scope of the present disclosure.

We claim:

1. A lens assembly, comprising:
a mounting base;
a lens holder;
an elastic part, comprising a first connection area, a second connection area, and an elastic body, the elastic body being connected between the first connection area and the second connection area, the first connection area being connected to the mounting base, the second connection area being connected to the lens holder; and
a stopping structure, disposed on the lens holder and/or the mounting base, the stopping structure comprising a first stopping part and a second stopping part, the first stopping part and the second stopping part protruding towards the opposite sides of the lens holder and the mounting base, and the first stopping part and the second stopping part being located on two sides of the elastic body.

2. The lens assembly according to claim 1, wherein a protrusion height of the second stopping part is greater than a protrusion height of the first stopping part, and a difference between the protrusion height of the second stopping part and the protrusion height of the first stopping part is within a predetermined range.

3. The lens assembly according to claim 2, wherein the difference between the protrusion height of the second stopping part and the protrusion height of the first stopping part is C, wherein, C is greater than 0 and less than or equal to 0.0387 millimeters.

4. The lens assembly according to claim 2, wherein the lens holder has a first contact position and a second contact position;
at the first contact position, the lens holder and the mounting base abut against each other through the second stopping part, and the first stopping part is in a spaced state from the lens holder or the mounting base;
at the second contact position, the lens holder and the mounting base abut against each other through the first stopping part and the second stopping part.

5. The lens assembly according to claim 2, wherein the elastic body comprises a first connection end and a second connection end, the first connection end is connected to the first connection area, the second connection end is connected to the second connection area;
the first stopping part is closer to the first connection end relative to the second stopping part.

6. The lens assembly according to claim 5, wherein the first connection end is connected to a side of the first connection area close to the first stopping part;
the second stopping part is located on a side of the first connection area away from the first stopping part, and the second connection area is disposed adjacent to the second stopping part.

7. The lens assembly according to claim 2, wherein the mounting base has a first surface, the first surface protrudes with a first connection platform;
the first connection area is disposed on a platform surface of the first connection platform, at least a portion of the elastic body is opposite to and spaced apart from the first surface.

8. The lens assembly according to claim 7, wherein in a direction where the lens holder is projected onto the mounting base, at least a portion of the first stopping part and at least a portion of the second stopping part overlap with an edge area of the lens holder, and the first connection area is staggered from the lens holder.

9. The lens assembly according to claim 7, wherein the lens holder has a second surface, the second surface faces the first surface, the second surface protrudes with a second connection platform;
the second connection area is disposed on a platform surface of the second connection platform, at least a portion of the elastic body is opposite to and spaced apart from the second surface.

10. The lens assembly according to claim 7, wherein the first connection area is a sheet-like structure, the protrusion height of the first stopping part and the second stopping part is greater than a thickness of the sheet-like structure;
when the elastic part is in a free state, the first connection area corresponds to a side surface of the first stopping part and a side surface of the second stopping part.

11. The lens assembly according to claim 7, wherein the elastic body comprises a first connection end and a second connection end, the first connection end is connected to the first connection area, the second connection end is connected to the second connection area;
the first connection area has a first side edge, the first side edge is located on a side of the first connection area close to the lens holder and is at an edge of the first connection platform, the first connection end is connected to the first side edge.

12. The lens assembly according to claim 11, wherein the first side edge comprises an avoidance segment and a connection segment in a length direction, the avoidance segment is located on the platform surface of the first connection platform, the connection segment, relative to the avoidance segment, is closer to an edge of the first connection platform and is connected to the first connection end;
the first stopping part is disposed adjacent to the connection segment, the second stopping part is disposed adjacent to the avoidance segment.

13. The lens assembly according to claim 11, wherein the first stopping part comprises a first stopping platform, the first stopping platform has a first stopping surface;
the second stopping part comprises a second stopping platform, the second stopping platform has a second stopping surface;
an area of the first stopping surface is larger than an area of the second stopping surface.

14. The lens assembly according to claim 13, wherein a connecting line on a side of the first stopping surface and the second stopping surface away from the lens holder passes through the first connection end and is located on a side of the first side edge close to the lens holder.

15. The lens assembly according to claim 13, wherein the first stopping platform and the second stopping platform are disposed on the mounting base, and the first stopping platform and the second stopping platform protrude towards the lens holder, a platform edge of the second stopping platform is provided with a rounded corner.

16. The lens assembly according to claim 13, wherein the second stopping part further comprises a third stopping platform;
the first stopping platform and the second stopping platform are disposed on the lens holder, and the first stopping platform and the second stopping platform protrude towards the mounting base, the third stopping platform is disposed on the mounting base, the third stopping platform protrudes towards the mounting base and corresponds to the second stopping platform, a platform edge of the second stopping platform and/or the third stopping platform is provided with a rounded corner.

17. The lens assembly according to claim 1, wherein multiple first stopping parts and multiple second stopping parts form a plurality of stopping units;
one of multiple elastic parts comprises a plurality of elastic units corresponding one-to-one to the plurality of stopping units, each elastic unit comprises the first connection area, the second connection area, and the elastic body, and the plurality of elastic units are located on sides of the plurality of elastic parts away from each other.

18. The lens assembly according to claim 17, wherein two elastic parts are oppositely disposed, each elastic part comprises a connection body, two ends of the connection body are connected to two second connection areas;
each elastic part comprises two elastic units, two first stopping parts corresponding to the same elastic part are located on sides of the two elastic units close to each other.

19. The lens assembly according to claim 18, wherein the stopping structure further comprises:
two third stopping parts, disposed on the lens holder and/or the mounting base, each third stopping parts protrudes towards the opposite sides of the lens holder and the mounting base, and a protrusion height of each third stopping parts is the same as that of the second stopping part;
the two third stopping parts are respectively disposed corresponding to the two elastic parts, each third stopping part is located between the corresponding two first stopping parts.

20. The lens assembly according to claim 19, wherein the stopping structure further comprises:
two rotation limiting parts, respectively disposed corresponding to the two third stopping parts, the rotation limiting parts are disposed on the lens holder and/or the mounting base and protrude towards the opposite sides of the lens holder and the mounting base, a side surface of the rotation limiting part is at least partially opposite to a side surface of the third stopping part.
